(19) United States
(12) Patent Application Publication
(10) Pub. No.: US 2023/0315241 A1
(43) Pub. Date: Oct. 5, 2023

(54) TOUCH PANEL

(71) Applicant: WUHAN CHINA STAR OPTOELECTRONICS SEMICONDUCTOR DISPLAY TECHNOLOGY CO., LTD., Wuhan (CN)

(72) Inventors: Liang FANG, Wuhan (CN); Ding DING, Wuhan (CN)

(73) Assignee: WUHAN CHINA STAR OPTOELECTRONICS SEMICONDUCTOR DISPLAY TECHNOLOGY CO., LTD., Wuhan (CN)

(21) Appl. No.: 17/264,883

(22) PCT Filed: Aug. 31, 2020
(86) PCT No.: PCT/CN2020/112512

§ 371 Date: Apr. 11, 2023

(30) Foreign Application Priority Data
Aug. 7, 2020 (CN) 202010787351.7

(51) Int. Cl. G06F 3/044

(52) U.S. Cl. CPC G06F 3/0448

(57) ABSTRACT

The embodiment of the present disclosure provides a touch panel, including a plurality of sets of touch induction units including a plurality of touch induction blocks, at least a touch integrated circuit, a plurality of touch signal lines, and a plurality of subtend electrodes; wherein at least the touch integrated circuit is connected to the plurality of touch induction blocks by the plurality of touch signal lines; wherein the plurality of touch induction blocks are arranged in sequence, and lengths of the plurality of touch signal lines corresponding to adjacent touch induction blocks are different; the plurality of touch induction blocks include a plurality of touch electrodes, and areas of the plurality of touch electrodes corresponding to the adjacent touch induction blocks are different.

### FIELD OF INVENTION

The present disclosure relates to a field of touch panel, and more particularly to a touch panel.

### BACKGROUND OF INVENTION

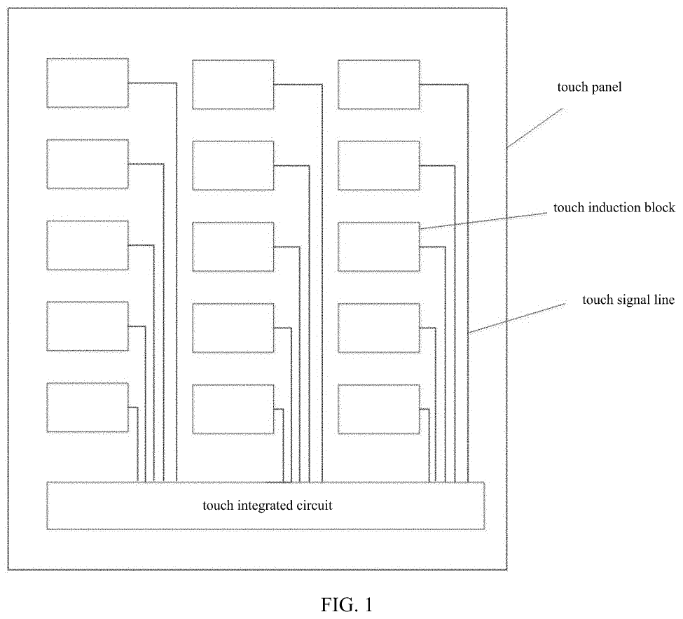

Display devices mainly include liquid crystal display (LCD) devices, plasma display panels (PDPs), organic light-emitting diode (OLED) panels, and active matrix organic light-emitting diode (AMOLED) panels, and have a broad range of application in vehicles, mobile phones, tablets, computers, and TV products. Generally speaking, a touch function has become one of standard configurations of most display devices, and resistive and capacitive technologies are mainly included. Wherein, capacitive touch screens are widely used. A basic principle is to use tools such as fingers or stylus to generate capacitance with a touch screen, and whether a panel is touched and a touch coordinate are confirmed by an electrical signal formed by a capacitance change before and after a touch. An important touch technology of capacitive touch panels is self-capacitive touch, which can realize a touch function through a layer of metal. A schematic diagram of a common touch panel design is shown in FIG. 1. Wherein, touch induction blocks and touch signal lines can be made of a same metal, such as a transparent oxide conductive material like indium tin oxide (ITO), or can be made of titanium(Ti)/aluminum(Al)/titanium(Ti) and aluminum alloys made as a grid pattern.

In above design method, due to different lengths of signal lines connecting different touch induction blocks, corresponding impedances are also different. A resistive capacitance loading (RC loading) problem causes touch devices to have touch characteristic differences in an area near a driving area and an area far away from the driving area, and affects a touch performance.

### SUMMARY

### Technical Problem

The embodiment of the present disclosure provides a touch panel to perform a differentiated pattern design on a touch induction block, so as to improve a difference in a touch performance caused by impedances of touch signal lines.

### SOLUTION TO TECHNICAL PROBLEM

### Technical Solution

In a first aspect, an embodiment of the present disclosure provides a touch panel, including: a plurality of sets of touch induction units including a plurality of touch induction blocks, at least a touch integrated circuit, a plurality of touch signal lines, and a plurality of subtend electrodes; at least the touch integrated circuit is connected to the plurality of touch induction blocks by the plurality of touch signal lines; the plurality of touch induction blocks are arranged in sequence, and lengths of the plurality of touch signal lines corresponding to adjacent touch induction blocks are different; the plurality of touch induction blocks include a plurality of touch electrodes, and areas of the plurality of touch electrodes corresponding to the adjacent touch induction blocks are different.

In the touch panel, when the areas of the plurality of touch electrodes corresponding to the adjacent touch induction blocks are different:

the adjacent touch induction blocks have a same pattern, and widths of the plurality of touch electrodes corresponding to the adjacent touch induction blocks are different.

In the touch panel, when the areas of the plurality of touch electrodes corresponding to the adjacent touch induction blocks are different:

the adjacent touch induction blocks have different patterns.

In the touch panel, when the areas of the plurality of touch electrodes corresponding to the adjacent touch induction blocks are different:

the plurality of touch electrodes corresponding to partial areas of the adjacent touch induction blocks are disconnected.

In the touch panel, when the areas of the plurality of touch electrodes corresponding to the adjacent touch induction blocks are different:

pattern densities corresponding to the adjacent touch induction blocks are changed.

In the touch panel, when the areas of the plurality of touch electrodes corresponding to the adjacent touch induction blocks are different:
partial areas of the adjacent touch induction blocks are without the touch electrodes.

In the touch panel, when the areas of the plurality of touch electrodes corresponding to the adjacent touch induction blocks are different:
the longer the lengths of the plurality of touch signal lines corresponding to the plurality of touch induction blocks are, the smaller the areas of the plurality of touch electrodes corresponding to the plurality of touch induction blocks are.

In the touch panel, materials of the plurality of touch electrodes include a transparent conductive oxide or a metal conductive material.

In a second aspect, an embodiment of the present disclosure provides a touch panel, including:
a plurality of sets of touch induction units including a plurality of touch induction blocks, at least a touch integrated circuit, a plurality of touch signal lines, and a plurality of subtend electrodes;
at least the touch integrated circuit is connected to the plurality of touch induction blocks by the plurality of touch signal lines;
the plurality of touch induction blocks are arranged in sequence, and lengths of the plurality of touch signal lines corresponding to adjacent touch induction blocks are different;
effective areas of the plurality of subtend electrodes corresponding to the adjacent touch induction blocks are different, and the effective areas are within an area range of the plurality of touch induction blocks.

In the touch panel, when the effective areas of the plurality of subtend electrodes corresponding to the adjacent touch induction blocks are different:
the plurality of subtend electrodes corresponding to the adjacent touch induction blocks have a same pattern, and widths of the plurality of subtend electrodes are different.

In the touch panel, when the effective areas of the plurality of subtend electrodes corresponding to the adjacent touch induction blocks are different:
the plurality of subtend electrodes corresponding to the adjacent touch induction blocks have different patterns.

### ADVANTAGES OF INVENTION

### Beneficial Effect

An embodiment of the present disclosure provides a touch panel, including: a plurality of sets of touch induction units including a plurality of touch induction blocks, at least a touch integrated circuit, a plurality of touch signal lines, and a plurality of subtend electrodes; at least the touch integrated circuit is connected to the plurality of touch induction blocks by the plurality of touch signal lines; the plurality of touch induction blocks are arranged in sequence, and lengths of the plurality of touch signal lines corresponding to adjacent touch induction blocks are different; the plurality of touch induction blocks include a plurality of touch electrodes, and areas of the plurality of touch electrodes corresponding to the adjacent touch induction blocks are different. The solution performs a differentiated pattern design on a touch induction block, so as to improve a difference in a touch performance caused by impedances of touch signal lines, thereby improving a touch performance of a product. The solution performs a differentiated pattern design on a touch induction block, so as to improve a difference in a touch performance caused by impedances of touch signal lines, thereby improving a touch performance of a product.

### BRIEF DESCRIPTION OF DRAWINGS

### Description of Drawings

In order to more clearly illustrate the technical solution in the present disclosure, the following will briefly illustrate the figures required in the present disclosure. It should be understood that the following figures are only some embodiments of the present disclosure, so it should not be seen as a limitation of the scope. For a person of ordinary skill in the art, without creative effort, other figures can also be obtained according to these figures.

FIG. 1 is structural schematic diagram of a touch panel of a conventional display device provided by a background technology according to an embodiment of the present disclosure.

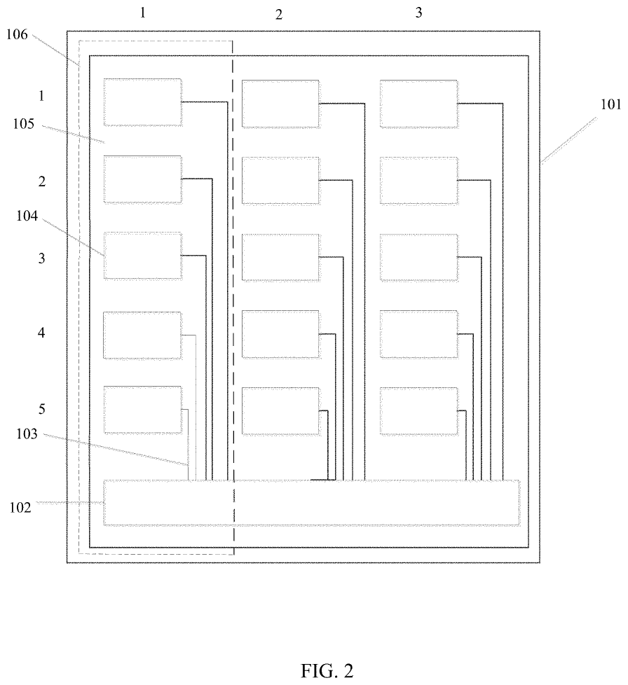

FIG. 2 is a structural schematic diagram of a touch panel according to an embodiment of the present disclosure.

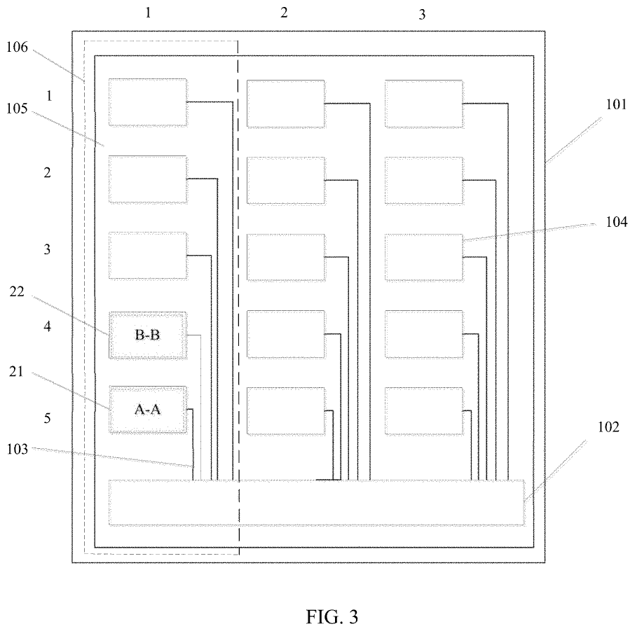

FIG. 3 is another structural schematic diagram of the touch panel according to an embodiment of the present disclosure.

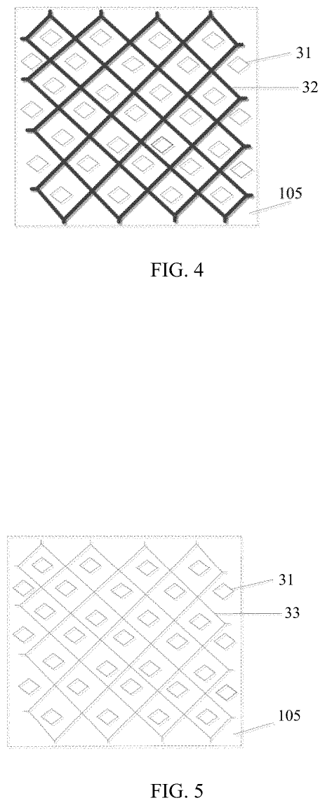

FIG. 4 is a structural schematic diagram of a grid pattern design of a touch induction block A-A according to an embodiment of the present disclosure.

FIG. 5 is a structural schematic diagram realizing a pattern differentiation design of a touch induction block B-B according to an embodiment of the present disclosure.

FIG. 6 is another structural schematic diagram realizing a pattern differentiation design of the touch induction block B-B according to an embodiment of the present disclosure.

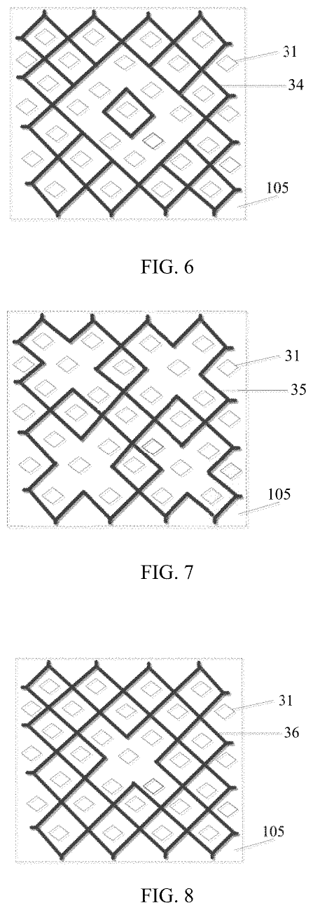

FIG. 7 is yet another structural schematic diagram realizing a pattern differentiation design of the touch induction block B-B according to an embodiment of the present disclosure.

FIG. 8 is still another structural schematic diagram realizing a pattern differentiation design of the touch induction block B-B according to an embodiment of the present disclosure.

### EMBODIMENTS OF INVENTION

### Detailed Description of Preferred Embodiments

An embodiment of the present disclosure provides a touch panel, which is mainly configured to realize a touch function of a touch input device including fingers, including: a plurality of sets of touch induction units comprising a plurality of touch induction blocks, at least a touch integrated circuit, a plurality of touch signal lines, and a plurality of subtend electrodes. At least the touch integrated circuit is connected to the plurality of touch induction blocks by the plurality of touch signal lines. The plurality of touch induction blocks are arranged in sequence, and lengths of the plurality of touch signal lines corresponding to adjacent touch induction blocks are different. The plurality of touch induction blocks comprise a plurality of touch electrodes, and areas of the plurality of touch electrodes corresponding to the adjacent touch induction blocks are different.

Please refer to FIG. 2, FIG. 2 is a structural design schematic diagram of a touch panel according to an embodiment of the present disclosure. As shown in FIG. 2, the touch panel includes a plurality of sets of touch induction units 106. A set of touch induction units 106 includes touch induction blocks 104, a touch integrated circuit 102, touch signal lines 103, and subtend electrodes 105 related to touch performances. The touch signal lines 103 connect the touch induction blocks 104 to the touch integrated circuit 102 to play a signal transmission function. The touch signal lines 103 and the touch induction blocks 104 can be designed in a same layer or in different layers. The plurality of touch induction blocks 104 in a set of touch induction units 106 are arranged in sequence, and lengths of the plurality of touch signal lines corresponding to adjacent touch induction blocks are different. The touch integrated circuit 102 is disposed at an end of a display device to realize a touch driving function, and design positions and number of the touch integrated circuit 102 are not limited to those shown in FIG. 2, and the present disclosure is not limited thereto. For example, two touch integrated circuits can be designed to be disposed on two ends of the touch panel. The touch induction blocks 104 include a touch electrode. Areas of the touch electrodes corresponding to the adjacent touch induction blocks are different, that is, touch electrode designs corresponding to the adjacent touch induction blocks are different. The longer lengths of the touch signal lines corresponding to the touch induction blocks, the smaller areas of the touch electrodes corresponding to the touch induction blocks. In an embodiment of the present disclosure, the subtend electrode 105 is a cathode. The subtend electrode 105 is designed with a whole surface, and is disposed under the touch induction blocks 104 and the touch signal lines 103.

Wherein, when areas of the touch electrodes corresponding to the adjacent touch induction blocks are different, the adjacent touch induction blocks have a same pattern, but widths of corresponding touch electrodes are different. The adjacent touch induction blocks have different patterns. A dummy pattern is designed on a generated pattern (that is, partial touch electrodes in the touch induction blocks are disconnected to form floating electrodes), or pattern densities are changed corresponding to the adjacent touch induction blocks, or partial areas of the adjacent touch induction blocks are without the touch electrodes.

Wherein, materials of the touch induction blocks can be transparent conductive oxides, such as indium tin oxide (ITO), and can also be metal conductive materials, such as titanium(Ti)/aluminum(Al)/titanium(Ti), and aluminum alloys, etc. When adopting non-transparent conductive oxide, metal should be designed with a grid pattern considering a light transmittance requirement of a display.

In an embodiment of the present disclosure, please refer to FIG. 3, the plurality of sets of touch induction units 106 are arranged side by side, that is, the plurality of touch induction blocks 104 are arranged in an M×N matrix. M and N respectively represent a number of the touch induction blocks in a row direction and in a column direction. Wherein, M and N are both positive integers, and M=3, and N=5 in FIG. 3. The touch integrated circuit 102 is disposed at a lower end of the touch panel 101.

In an embodiment of the present disclosure, the touch induction blocks 104 are designed in a grid pattern. The touch induction block in row 5 and column 1 is disposed as A-A (21), and the touch induction block in row 4 and column 1 is disposed as B-B (22) in FIG. 3. Please refer to FIG. 4, FIG. 4 is a grid pattern design of the touch induction block A-A (21) according to an embodiment of the present disclosure. The touch induction block A-A (21) includes a plurality of pixel units 31 arranged in an array. Touch electrode 32 avoids the pixel units 31 to form a grid pattern, and an area of the touch electrode 32 is SM. Wherein, the touch electrode is composed of metal traces. The metal traces overlap with a lower cathode to form an overlapping area, that is, an area Src of the touch electrode. Wherein, r represents the rth row, and c represents the cth column. When a value of r is the same, designs of the touch electrodes are the same, and correspondingly, values of the area Src of the touch electrodes are the same. The smaller the value of r, the smaller the value of the area Src of the touch electrode.

Please refer to FIG. 5, FIG. 5 is a method for realizing a pattern differentiation design of the touch induction block B-B (22). The area of the touch electrode of the touch induction block A-A (21) is S51, and the area of the touch electrode of the touch induction block B-B is S41. The touch induction block B-B and the touch induction block A-A have a same grid pattern, but a width of the touch electrode 33 of the touch induction block B-B are changed. The with of the touch electrode 33 of the touch induction block B-B is less than a width of the touch electrode 32 of the touch induction block A-A, so the area of the touch electrode of the touch induction block B-B is smaller than the area of the touch electrode of the touch induction block A-A, and a capacitance C41 of the touch induction block B-B is smaller than a capacitance C51 of the touch induction block A-A. Since a length of a touch connection line corresponding to the touch induction block B-B is greater than a length of a touch connection line corresponding to the touch induction block A-A, an impedance of the touch connection line corresponding to the touch induction block B-B is also greater. By reducing the width of the touch electrode of the touch induction block B-B, the area S41 of the touch electrode of the touch induction block B-B is reduced, thereby reducing the capacitance C41. By using the capacitance to compensate an impedance difference caused by the touch signal lines, a performance difference of the touch panel is reduced, and a market competitiveness of a touch performance of a product is improved.

Wherein, the method for realizing the pattern differentiation design of the touch induction block B-B (22) and the touch induction block A-A (21) is not limited to that shown in FIG. 5. Please refer to FIG. 6, FIG. 7, and FIG. 8. As shown in FIG. 6, in the grid pattern of the touch induction block B-B, traces of the touch induction block B-B are partially disconnected to form floating electrodes, and disconnected traces are not electrically connected to signal lines, and have no signal transmission. Therefore, the area of the touch electrode 34 is smaller than the area of the touch electrode 33 of the touch induction block A-A. As shown in FIG. 7, grid pattern densities of the touch induction block B-B are changed, and the area of the touch electrode 35 is smaller than the area of the touch electrode 33 of the induction block A-A. As shown in FIG. 8, partial areas of the touch induction block B-B are without the traces, and an area of the touch electrode 36 is smaller than the area of touch electrode 33 of the touch induction block A-A. Wherein, the pattern of the touch induction block can be a grid shape, or a block shape with a whole surface. Wherein, the differentiation design of the touch induction blocks in the row direction is not limited in the present disclosure, and is not limited to examples provided by the present disclosure.

Wherein, it can be known from a capacitance formula C=K×S/d, wherein K represents a dielectric constant, d represents a relative distance between plates, and S represents the area of the touch electrode, by the pattern differentiation design of the touch induction block, an area S of the touch electrode can be changed, so that a capacitance C is changed. The larger a corresponding value of r, the larger the area Src of the touch electrode, and the larger a capacitance Crc.

An embodiment of the present disclosure provides a touch panel, including: a plurality of sets of touch induction units comprising a plurality of touch induction blocks, at least a touch integrated circuit, a plurality of touch signal lines, and a plurality of subtend electrodes. Wherein, at least the touch integrated circuit is connected to the plurality of touch induction blocks by the plurality of touch signal lines. Wherein the plurality of touch induction blocks are arranged in sequence, and lengths of the plurality of touch signal lines corresponding to adjacent touch induction blocks are different. Wherein, effective areas of the plurality of subtend electrodes corresponding to the adjacent touch induction blocks are different, and the effective areas are within an area range of the plurality of touch induction blocks.

Wherein, the touch signal lines connect the touch induction blocks to the touch integrated circuit. The touch signal lines and the touch induction blocks can be designed in a same layer or in different layers. The touch integrated circuit is disposed on an end of a display device to realize a touch driving function. Wherein, design positions and number of the touch integrated circuit are not limited, and the present disclosure is not limit thereto. For example, two touch integrated circuits can be designed to be disposed on two ends of the touch panel. Materials of the subtend electrode can be transparent conductive oxides or metal conductive materials.

Wherein, in an embodiment of the present disclosure, the subtend electrode can be a cathode. Effective areas of the cathodes corresponding to the adjacent touch induction blocks are within an area range of the adjacent touch induction blocks. The touch electrodes of the adjacent touch induction blocks are not designed with patterns. The effective areas of the cathodes corresponding to the adjacent touch induction blocks are changed by changing patterns of the cathodes corresponding to the adjacent touch induction blocks, so that the capacitances of the adjacent touch induction blocks are different, and impedance differences caused by different corresponding touch signal lines are compensated. The longer the length of the touch signal line corresponding to the touch induction line of adjacent touch induction line, the smaller the effective area of the cathode corresponding to the touch induction line.

Wherein, when the effective areas of the cathodes corresponding to the adjacent touch induction blocks are different, the cathodes corresponding to the adjacent touch induction blocks have a same pattern in the effective areas, but the width of the cathodes are different. When the cathodes corresponding to the adjacent touch induction blocks have the same pattern in the effective areas, different pattern designs are not limited in the present disclosure. When the cathodes corresponding to the adjacent touch induction blocks have the same pattern in the effective areas, a dummy pattern is designed on a generated pattern (that is, partial touch electrodes in the touch induction block are disconnected to form floating electrodes), or pattern densities of the cathodes are changed corresponding to the adjacent touch induction blocks, or partial areas of the cathodes corresponding to the adjacent touch induction blocks are without the touch electrodes. The pattern of the subtend electrode can be a grid shape, a block shape with a whole surface, or the like.

In an embodiment of the present disclosure, the touch induction blocks of the touch panel are performed different pattern designs, so that the areas of the touch electrodes of the touch induction blocks in different rows are different to form different capacitances. By using the capacitance to compensate an impedance difference caused by the touch signal lines, a performance difference of the touch panel is reduced, and a market competitiveness of a touch performance of a product is improved. Furthermore, a differentiated design of the touch induction block does not increase a manufacturing process. The present disclosure is applicable to both self-capacitive touch and mutual-capacitive touch.

The above is the detailed introduction of the touch panel according to embodiments of the present disclosure, the principle and the implementation mode of the present disclosure are elaborated by means of specific examples, and the illustration for the above embodiments are merely used to understand the present disclosure. Meanwhile, the specific embodiments and the applied ranges can be changed for those skilled in the art according to the concept of the present disclosure. In general, the content of the present specification should not be construed to limit the present disclosure.

1. A touch panel, comprising:
a plurality of sets of touch induction units comprising a plurality of touch induction blocks, at least a touch integrated circuit, a plurality of touch signal lines, and a plurality of subtend electrodes;
wherein at least the touch integrated circuit is connected to the plurality of touch induction blocks by the plurality of touch signal lines;
wherein the plurality of touch induction blocks are arranged in sequence, and lengths of the plurality of touch signal lines corresponding to adjacent touch induction blocks are different;
wherein the plurality of touch induction blocks comprise a plurality of touch electrodes, and areas of the plurality of touch electrodes corresponding to the adjacent touch induction blocks are different.

2. The touch panel as claimed in claim 1, wherein when the areas of the plurality of touch electrodes corresponding to the adjacent touch induction blocks are different, the adjacent touch induction blocks have a same pattern, and widths of the plurality of touch electrodes corresponding to the adjacent touch induction blocks are different.

3. The touch panel as claimed in claim 1, wherein when the areas of the plurality of touch electrodes corresponding to the adjacent touch induction blocks are different, the adjacent touch induction blocks have different patterns.

4. The touch panel as claimed in claim 3, wherein when the areas of the plurality of touch electrodes corresponding to the adjacent touch induction blocks are different, the plurality of touch electrodes corresponding to partial areas of the adjacent touch induction blocks are disconnected.

5. The touch panel as claimed in claim 3, wherein when the areas of the plurality of touch electrodes corresponding to the adjacent touch induction blocks are different, pattern densities corresponding to the adjacent touch induction blocks are changed.

6. The touch panel as claimed in claim 3, wherein when the areas of the plurality of touch electrodes corresponding to the adjacent touch induction blocks are different, partial areas of the adjacent touch induction blocks are without the touch electrodes.

7. The touch panel as claimed in claim 1, wherein when the areas of the plurality of touch electrodes corresponding to the adjacent touch induction blocks are different, the longer the lengths of the plurality of touch signal lines corresponding to the plurality of touch induction blocks are, the smaller the areas of the plurality of touch electrodes corresponding to the plurality of touch induction blocks are.

8. The touch panel as claimed in claim 1, wherein materials of the plurality of touch electrodes comprise a transparent conductive oxide or a metal conductive material.

9. The touch panel as claimed in claim 1, wherein the plurality of touch signal lines and the plurality of touch induction blocks are disposed on a same layer or different layers.

10. The touch panel as claimed in claim 2, wherein the pattern of the plurality of touch induction blocks comprises a grid shape, and a block shape with a whole surface.

11. A touch panel, comprising:
a plurality of sets of touch induction units comprising a plurality of touch induction blocks, at least a touch integrated circuit, a plurality of touch signal lines, and a plurality of subtend electrodes;
wherein at least the touch integrated circuit is connected to the plurality of touch induction blocks by the plurality of touch signal lines;
wherein the plurality of touch induction blocks are arranged in sequence, and lengths of the plurality of touch signal lines corresponding to adjacent touch induction blocks are different;
wherein effective areas of the plurality of subtend electrodes corresponding to the adjacent touch induction blocks are different, and the effective areas are within an area range of the plurality of touch induction blocks and the effective areas are smaller than areas of corresponding touch induction blocks.

12. The touch panel as claimed in claim 11, wherein when the effective areas of the plurality of subtend electrodes corresponding to the adjacent touch induction blocks are different, the plurality of subtend electrodes corresponding to the adjacent touch induction blocks have a same pattern, and widths of the plurality of subtend electrodes are different.

13. The touch panel as claimed in claim 11, wherein when the effective areas of the plurality of subtend electrodes corresponding to the adjacent touch induction blocks are different, the plurality of subtend electrodes corresponding to the adjacent touch induction blocks have different patterns.

14. The touch panel as claimed in claim 13, wherein when the effective areas of the plurality of subtend electrodes corresponding to the adjacent touch induction blocks are different, the plurality of subtend electrodes corresponding to partial areas of the adjacent touch induction blocks are disconnected.

15. The touch panel as claimed in claim 13, wherein when the effective areas of the plurality of subtend electrodes corresponding to the adjacent touch induction blocks are different, pattern densities of the plurality of subtend electrodes corresponding to the adjacent touch induction blocks are changed.

16. The touch panel as claimed in claim 13, wherein when the effective areas of the plurality of subtend electrodes corresponding to the adjacent touch induction blocks are different, partial areas of the adjacent touch induction blocks are without the subtend electrodes.

17. The touch panel as claimed in claim 11, wherein when the effective areas of the plurality of subtend electrodes corresponding to the adjacent touch induction blocks are different, the longer the lengths of the plurality of touch signal lines corresponding to the plurality of touch induction blocks are, the smaller the effective areas of the plurality of subtend electrodes corresponding to the plurality of touch induction blocks are.

18. The touch panel as claimed in claim 11, wherein materials of the plurality of subtend electrodes comprise a transparent conductive oxide or a metal conductive material.

19. The touch panel as claimed in claim 11, wherein the plurality of touch signal lines and the plurality of touch induction blocks are disposed on a same layer or different layers.

20. The touch panel as claimed in claim 12, wherein the pattern of the plurality of subtend electrodes comprises a grid shape, and a block shape with a whole surface.
